(19) United States
(12) Patent Application Publication
(10) Pub. No.: US 2010/0237802 A1
(43) Pub. Date: Sep. 23, 2010

(54) CURRENT BALANCING DEVICE, LED LIGHTING DEVICE, AND LCD B/L MODULE

(75) Inventors: Shinji ASO, Niiza-shi (JP); Kengo Kimura, Niiza-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/722,999

(22) Filed: Mar. 12, 2010

(30) Foreign Application Priority Data
Mar. 18, 2009 (JP) 2009-066151

(51) Int. Cl. H05B 41/36

(52) U.S. Cl. 315/294

(57) ABSTRACT

A current balancing device includes: a power supply that outputs sinusoidal alternating-current; and a plurality of series circuits, each of the series circuits including a full-wave rectifier, one or more of windings, and one or more of loads in series connection, the full-wave rectifier connected to an output of the power supply and performing full-wave rectification for the alternating-current of the power supply. Currents flowing in the respective series circuits are balanced based on an electromagnetic force generated in one or more of the windings.

### BACKGROUND OF THE INVENTION

1. Field of the Invention

The present invention relates to a current balancing device for balancing a current flowing in a plurality of loads connected in parallel, an LED lighting device, and an LCD B/L module.

2. Description of the Related Art

Patent Publication 1 (Japanese Patent Application Laid-Open Publication No. 2004-319583) and Patent Publication (Japanese Patent Application Laid-Open Publication No. 2006-012659) has been known as a conventional LED lighting device lighting a plurality of LEDs (Light Emitting Diodes) connected in series.

The LED lighting device disclosed in Patent Publication 1 is configured that a plurality of LED units are connected in parallel, in which a plurality of LEDs are connected in series. Each voltage drop of the LED units (each forward voltage Vf of the LED) varies widely. Thus, currents of the LED units become imbalanced when the LED units in which a plurality of LEDs connected in series are driven while a plurality of LED units are connected in parallel. The device in Patent Publication 1 then applies constant currents to the respective LED units by a constant current circuit. As a result, the currents flowing in the LED units are balanced.

An electric-discharge lamp lighting circuit disclosed in Patent Publication 2 balances currents flowing in a plurality of CCFLs (cold cathode fluorescent lamps) connected in parallel by use of balance transformers. A sinusoidal current flows in the balance transformers since the CCFLs are driven on alternating-current. Each of the CCFLs and a primary winding of each of the balance transformers are thus connected in series so that secondary windings of the balance transformers are configured to be a closed circuit. Accordingly, the currents flowing in the CCFLs connected in parallel are balanced.

### SUMMARY OF THE INVENTION

However, in Patent Publication 1, a difference of voltage drops of the respective LED units is to be a loss when the constant current circuit is connected.

While, in Patent Publication 2, a loss due to a variation of voltages of the CCFLs is not caused since the currents are balanced by use of the balance transformers. However, an LED that only applies direct-current cannot be balanced the direct-current by the balance transformers. While the balance transformer is able to construct in smaller size as a driving frequency is higher, the balance transformer constructs in larger size as the frequency is lower. In addition, the balance transformer cannot be used on direct-current since the transformer is saturated.

It is an object of the present invention to provide a current balancing device, an LED lighting device, and an LCD B/L (liquid crystal display back light) module, to achieve a reduction of a loss caused by balancing currents flowing in a plurality of loads having different impedance and achieving a high efficiency in a power supply.

To solve the above-mentioned problems, a current balancing device includes: a power supply that outputs sinusoidal alternating-current; and a plurality of series circuits, each of the series circuits including a full-wave rectifier, one or more of windings, and one or more of loads in series connection, the full-wave rectifier connected to an output of the power supply and performing full-wave rectification for the alternating-current of the power supply. Currents flowing in the respective series circuits are balanced based on an electromagnetic force generated in one or more of the windings.

An LED lighting device according to a second aspect of the present invention includes: a power converter for converting an ac power from a commercial ac power source to an arbitrary ac power so as to supply alternating-current; and a current balancing device for balancing first currents and a second current based on an electromagnetic force generated in one or more of windings, the first currents flowing in a plurality of series circuits, each of the series circuits including a full-wave rectifier connected to an output of the power converter and performing full-wave rectification for the alternating-current, one or more of the windings, and one or more of LED loads in series connection, and the second current flowing in one or more of the LED loads.

An LCD B/L module according to a third aspect of the present invention includes: an LCD cell; and a current balancing device that balances first currents and a second current based on an electromagnetic force generated in one or more of windings, the first currents flowing in a plurality of series circuits, each of the series circuit including a full-wave rectifier, one or more of the windings, and one or more of LED loads in series connection, the second current flowing in one or more of the LED loads, the full-wave rectifier connected to an output of a power converter that converts an ac power from a commercial ac power source to an arbitrary ac power so as to supply alternating-current and performing full-wave rectification for the alternating-current.

According to the aspects of the present invention, the currents supplied to the plurality of the loads from the output of the power supply are balanced based on the electromagnetic force generated at one or more of the windings connected to one or more of the loads in series. In addition, the currents are balanced due to the electromagnetic force generated at one or more of the windings. Thus, the loss caused by the impedance difference of the loads can be reduced. Therefore, it is possible to achieve a reduction of a loss caused by balancing the currents flowing in the loads having different impedance and achieve a high efficiency in the power supply. Moreover, the full-wave rectification is performed with respect to alternating-current by the full-wave rectifier, thereby supplying to one or more of the loads.

### BRIEF DESCRIPTION OF THE DRAWINGS

FIG. 1 is a configuration diagram of a current balancing device in embodiment 1 of the present invention.

FIG. 2 is operational waveforms of the current balancing device in embodiment 1 of the present invention.

FIG. 3 is a configuration diagram of a current balancing device in a embodiment 2 of the present invention.

FIG. 4 is operational waveforms of the current balancing device in embodiment 2 of the present invention.

FIG. 5 is a configuration diagram of a current balancing device in embodiment 3 of the present invention.

FIG. 6 is a configuration diagram of a current balancing device in a embodiment 4 of the present invention.

FIG. 7 is a configuration diagram of a current balancing device in embodiment 5 of the present invention.

FIG. 8 is a configuration diagram of a current balancing device in embodiment 6 of the present invention.

FIG. 9 is a configuration diagram of a current balancing device in embodiment 7 of the present invention.

FIG. 10 is a configuration diagram of a current balancing device in embodiment 8 of the present invention.

FIG. 11 is a configuration diagram of a current balancing device in embodiment 9 of the present invention.

FIG. 12 is operational waveforms for explaining reset operations of balance transformers of the current balancing device in embodiment 9 of the present invention.

### DESCRIPTION OF THE EMBODIMENTS

Hereinafter, a description will be made below in detail of current balancing devices in embodiments of the present invention with reference to the drawings. In each of embodiments described below, a case where a plurality of LEDs are used for loads having different impedance in the current balancing device is described.

### Embodiment 1

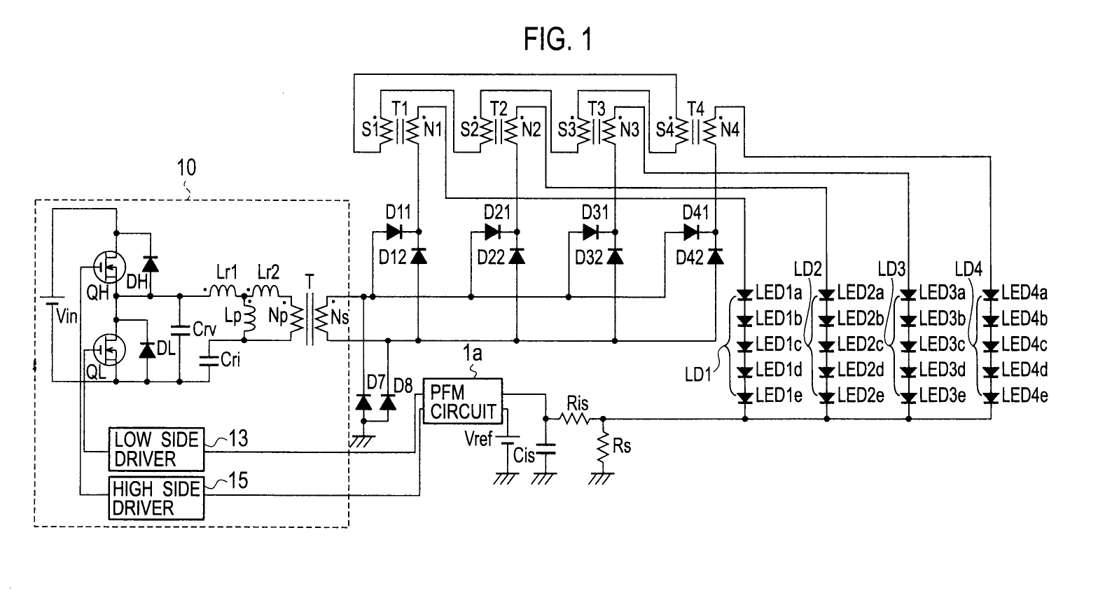

In embodiment 1 illustrated in FIG. 1, a power supply 10 supplies sinusoidal alternating-current to a current balancing device. The current balancing device smoothes the alternating-current supplied from the power supply 10 so as to supply to loads.

In embodiment 1 illustrated in FIG. 1, both ends of a do power supply Vin are connected to a series circuit including a first switching element QH composed of a MOSFET and a second switching element QL composed of a MOSFET for supplying the sinusoidal alternating-current to the current balancing device. A connection point of the first switching element QH and the second switching element QL is connected to a series resonant circuit composed of a primary winding Np of a power transformer T and a current resonant capacitor Cri. The power transformer T has leakage inductances Lr1 and Lr2. The power transformer T has a magnetizing inductance Lp. A low side driver 13 drives the second switching element QL. A high side driver 15 drives the first switching element QH.

The power supply 10 alternatively turns on and off the first switching element QH and the second switching element QL. Thus, sinusoidal currents resonated at the leakage inductances Lr1 and Lr2 and the current resonant capacitor Cri are supplied to the current balancing device from a secondary winding Ns of the power transformer T.

One end of the secondary winding Ns of the power transformer T is connected to an anode of a diode D11, in which a half-wave rectification is performed with respect to alternating-current. The other end of the secondary winding Ns of the power transformer T is connected to an anode of a diode D12, in which a half-wave rectification is performed with respect to alternating-current. A cathode of the diode D11 and a cathode of the diode D12 are connected to one end of a first primary winding N1.

The diodes D11 and D12 compose a first full-wave rectifier.

The other end of the first primary winding N1 is connected to a first load LD1 (LED1a to LED1e). A first series circuit is composed of the first full-wave rectifier (D11 and D12), the first primary winding N1, and the first load LD1.

One end of the secondary winding Ns of the power transformer T is connected to an anode of a diode D21, in which a half-wave rectification is performed with respect to alternating-current. The other end of the secondary winding Ns of the power transformer T is connected to an anode of a diode D22, in which a half-wave rectification is performed with respect to alternating-current. A cathode of the diode D21 and a cathode of the diode D22 are connected to one end of a second primary winding N2.

The diodes D21 and D22 compose a second full-wave rectifier. The other end of the second primary winding N2 is connected to a second load LD2 (LED2a to LED2e). A second series circuit is composed of the second full-wave rectifier (D21 and D22), the second primary winding N2, and the second load LD2.

One end of the secondary winding Ns of the power transformer T is connected to an anode of a diode D31, in which a half-wave rectification is performed with respect to alternating-current. The other end of the secondary winding Ns of the power transformer T is connected to an anode of a diode D32, in which a half-wave rectification is performed with respect to alternating-current. A cathode of the diode D31 and a cathode of the diode D32 are connected to one end of a third primary winding N3.

The diodes D31 and D32 compose a third full-wave rectifier. The other end of the third primary winding N3 is connected to a third load LD3 (LED3a to LED3e). A third series circuit is composed of the third full-wave rectifier (D31 and D32), the third primary winding N3, and the third load LD3.

One end of the secondary winding Ns of the power transformer T is connected to an anode of a diode D41, in which a half-wave rectification is performed with respect to alternating-current. The other end of the secondary winding Ns of the power transformer T is connected to an anode of a diode D42, in which a half-wave rectification is performed with respect to alternating-current. A cathode of the diode D41 and a cathode of the diode D42 are connected to one end of a fourth primary winding N4.

The diodes D41 and D42 compose a fourth full-wave rectifier. The other end of the fourth primary winding N4 is connected to a fourth load LD4 (LED4a to LED4e). A fourth series circuit is composed of the fourth full-wave rectifier (D41 and D42), the fourth primary winding N4, and the fourth load LD4.

The first primary winding N1 and a first secondary winding S1 are magnetically coupled to each other and compose a first balance transformer T1. The second primary winding N2 and a second secondary winding S2 are magnetically coupled to each other and compose a second balance transformer T2. The third primary winding N3 and a third secondary winding S3 are magnetically coupled to each other and compose a third balance transformer T3. The fourth primary winding N4 and a fourth secondary winding S4 are magnetically coupled to each other and compose a fourth balance transformer T4. The respective secondary windings S1, S2, S3 and S4 are connected in series so as to form a closed loop. An impedance of the first load LD1, an impedance of the second load LD2, an impedance of the third load LD3 and an impedance of the fourth load LD4 in embodiment 1 are different from one another.

The current balancing device in embodiment 1 of the present invention includes a current detector for detecting currents in a plurality of series circuits, a comparator for comparing current detection values detected at the current detector to a reference voltage, and a controller for controlling alternating-current according to an output of the comparator.

A resistor Rs as the current detector and diodes D7 and D8 are added between the loads LD1, LD2, LD3 and LD4 and the secondary winding Ns of the power transformer T. An input terminal of a filter circuit composed of a resistor Ris and a capacitor Cis is connected to a connection point of the loads LD1, LD2, LD3 and LD4, and the resistor Rs. One of input terminals of a PFM circuit 1a as the comparator and the controller is connected to an output terminal of the filter circuit. The other input terminal is connected to a reference voltage Vref that is a positive voltage.

The resistor Rs detects currents flowing in the loads LD1, LD2, LD3 and LD4 concurrently, and outputs the current detection values to the PFM circuit 1a via the filter circuit. The PFM circuit 1a compares the current detection values to the reference voltage Vref, and controls on/off frequencies of the first switching element QH and the second switching element QL based on corresponding error output so that the currents flowing in the loads are to be constant.

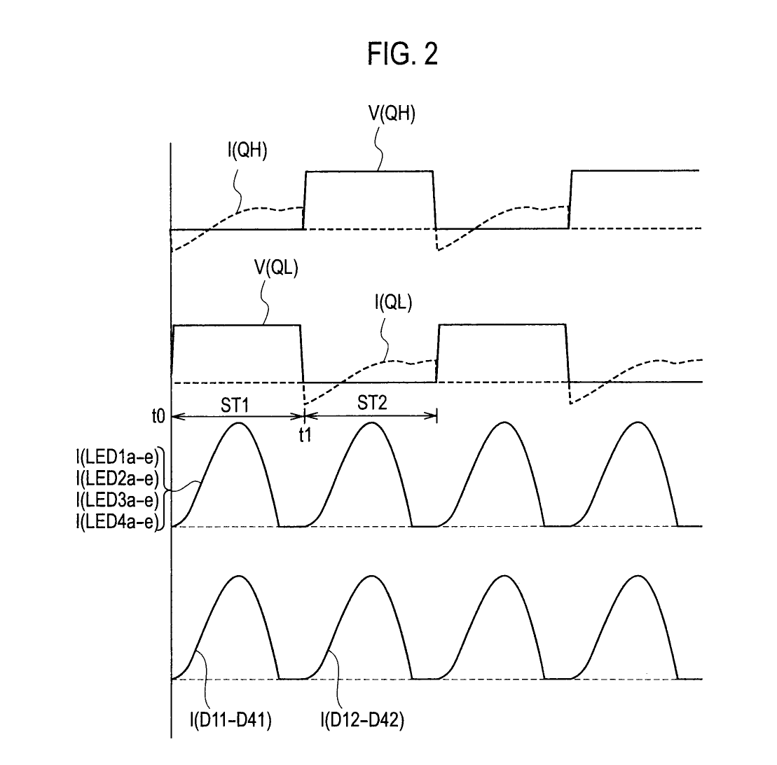

FIG. 2 is operational waveforms of the current balancing device in embodiment 1. In FIG. 2, V(QH) is a drain-source voltage of the first switching element QH, I(QH) is a current flowing in the drain of the first switching element QH, V(QL) is a drain-source voltage of the second switching element QL, I(QL) is a current flowing in the drain of the second switching element QL, I(D11-D41) are currents flowing in the diodes D11, D21, D31, and D41, I(D12-D42) are currents flowing in the diodes D12, D22, D32, and D42, I(LED1a-e) are currents flowing in the LED1a to LED1e, I(LED2a-e) are currents flowing in the LED2a to LED2e, I(LED3a-e) are currents flowing in the LED3a to LED3e, and I(LED4a-e) are currents flowing in the LED4a to LED4e.

First, at a time t0, the first switching element QH is turned on when the second switching element QL is at off state. Then, a winding start of the primary winding Np of the power transformer T becomes a positive voltage. Also, a winding start of the secondary winding Ns of the power transformer T becomes a positive voltage.

Thus, during a period ST1 starting from the time t0, the first to fourth series circuits connected to the secondary winding Ns pass currents in a route along Ns→D11→N1→the load LD1→Rs→D8→Ns, in a route along Ns→D21→N2→the load LD2→Rs→D8→Ns, in a route along Ns→D31→N3→the load LD3→Rs→D8→Ns, and in a route along Ns→D41→N4→the load LD4→Rs→D8→Ns, respectively.

In this case, the current I(QH) flowing in the first switching element QH starts flowing as a negative value in a route along Vin (positive electrode)→QH (DH)→Lr1→Lp→Cri→Vin (negative electrode), and in a route along Vin (positive electrode)→QH (DH)→Lr1→Lr2→Np→Cri→Vin (negative electrode). Then, the current I(QH) increases with time due to a resonance of the current resonant capacitor Cri, the magnetizing inductance Lp, and the leakage inductance Lr1. At the same time, the current resonant capacitor Cri is charged.

Thus, the respective series circuits pass the currents I(D11), I(D21), I(D31) and I(D41) that are temporally changed in magnitude, i.e. have an ac component.

The current I(D11) flows in the first primary winding N1 and the first secondary winding S1. The current I(D21) flows in the second primary winding N2 and the second secondary winding S2. The current I(D31) flows in the third primary winding N3 and the third secondary winding S3. The current I(D41) flows in the fourth primary winding N4 and the fourth secondary winding S4. The respective primary windings N1, N2, N3, and N4 and the respective secondary windings S1, S2, S3, and S4 tend to generate magnetic fluxes corresponding to each current. In this case, the first primary winding N1 and the first secondary winding S1 compose the first balance transformer T1. The second primary winding N2 and the second secondary winding S2 compose the second balance transformer T2. The third primary winding N3 and the third secondary winding S3 compose the third balance transformer T3. The fourth primary winding N4 and the fourth secondary winding S4 compose the fourth balance transformer T4. Thus, the respective magnetic fluxes generated in each winding interact with one another in order to average the magnitudes of the magnetic fluxes. Therefore, even when the respective currents I(D11), I(D21), I(D31) and I(D41) fundamentally have different magnitudes, the currents are balanced so as to have a same value, thereby supplying to the loads LD1, LD2, LD3 and LD4, respectively. Thus, each load LD1, LD2, LD3 and LD4 has different impedance. However, the current I(D11) of the first series circuit, the current I(D21) of the second series circuit, the current I(D31) of the third series circuit, and the current I(D41) of the fourth series circuit are to be equal to one another.

In addition, in embodiment 1, a loss mainly based on winding resistance is caused since the currents are balanced due to the electromagnetic force generated in the windings.

However, such a loss is smaller than the loss in the constant current circuit in Patent Publication 1. Therefore, it is possible to reduce the loss caused by balancing the currents.

Moreover, embodiment 1 relates to a lighting device in which each load LD1, LD2, LD3, and LD4 includes a plurality of LEDs connected in series. Therefore, the LEDs can emit light uniformly by supplying the balanced currents to the respective loads LD1, LD2, LD3 and LD4. Accordingly, a liquid crystal display (LCD) can uniformly emit light, for example.

Next, at a time t1, the first switching element QH is turned off, and the second switching element QL is turned on. Then, currents flow in a route along Cri→DL (QL)→Lr1→Lp→Cri and in a route along Cri→Np→Lr2→Lr1→QL (DL)→Cri. Therefore, the winding start of the primary winding Np of the power transformer T becomes a negative voltage. Also, the winding start of the secondary winding Ns of the power transformer T becomes a negative voltage.

Thus, during a period ST2 starting from the time t1, the diodes D12, D22, D32 and D42 respectively connected to the first to fourth series circuits are electrically conducting. Then, currents flow in a route along Ns→D12→N1→the load LD1→Rs→D7→Ns, in a route along Ns→D22→N2→the load LD2→Rs→D7→Ns, in a route along Ns→D32→N3→the load LD3→Rs→D7→Ns, and in a route along Ns→D42→N4→the load LD4→Rs→D7→Ns.

The currents are supplied from the current resonant capacitor Cri in a route along Cri→Np→Lr2→Lr1→QL (DL)→Cri via the power transformer T. Therefore, the currents flow due to a resonance of the current resonant capacitor Cri and the leakage inductances Lr1 and Lr2. As a result, sinusoidal half-wave currents are supplied. Thus, the respective series circuits pass the currents I(D12), I(D22), I(D32), and I(D42) that are temporally changed in magnitude, i.e. have an ac component. In addition, as shown in FIG. 2, the load currents I(LED1a-LED1e), I(LED2a-LED2e), I(LED3a-LED3e), and I(LED4a-LED4e) approximately have the same waveforms as the currents I(D11), I(D21), I(D31), and I(D41) and the currents I(D12), I(D22), I(D32), and I(D42).

Therefore, the currents supplied to the loads from the output of the power supply 10 are balanced based on the electromagnetic force generated in one or more of the windings connected to one or more of the loads in series. Moreover, since the currents are balanced due to the electromagnetic force generated in one or more of the windings, the loss caused by the impedance difference of the loads can be reduced. Accordingly, the current balancing device in embodiment 1 can achieve a reduction of the loss caused by balancing the currents flowing in the loads having different impedance, and achieve a high efficiency in the power supply. In addition, it is possible to achieve a low-noise device since the sinusoidal currents flow in the current balancing device. Furthermore, the full-wave rectified alternating-current is supplied to each load LD1, LD2, LD3, and LD4 by the diodes D11, D12, D21, D22, D31, D32, D41, and D42 that are a full-wave rectifier.

### Embodiment 2

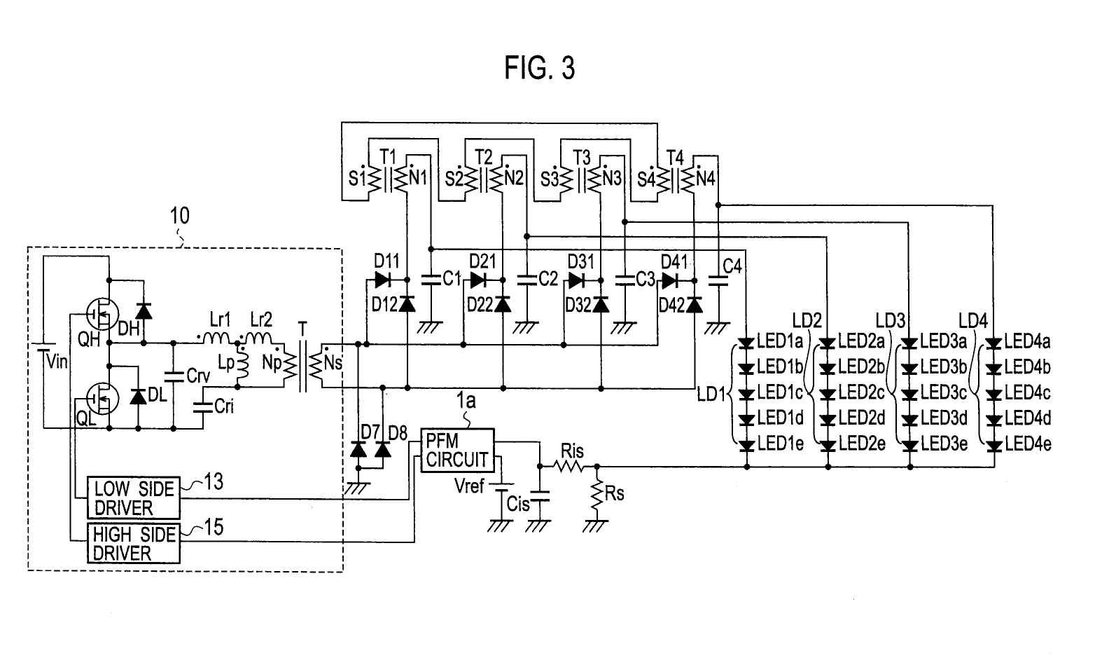

The current balancing device in embodiment 2 illustrated in FIG. 3 is configured to include smoothing capacitors C1, C2, C3, and C4 and be supplied with currents smoothed by the respective loads LD1, LD2, LD3, and LD4, with respect to the current balancing device in embodiment 1 illustrated in FIG. 1.

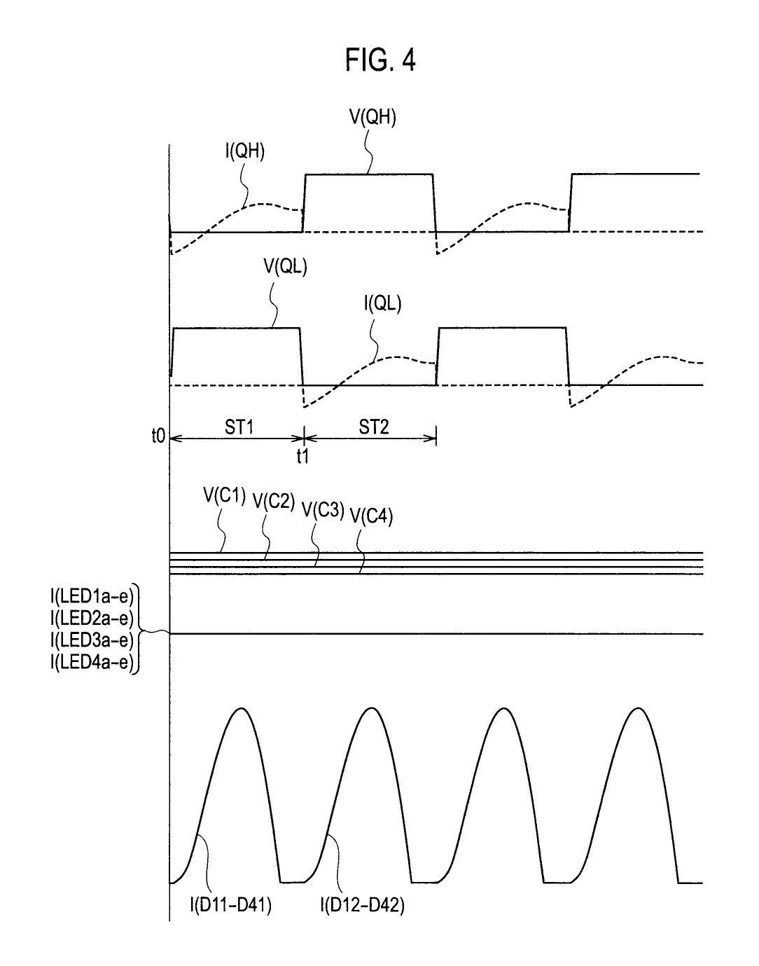

FIG. 4 is operational waveforms of the current balancing device in embodiment 2 of the present invention. In FIG. 4, V(C1) is terminal voltages of the first capacitor C1, V(C2) is terminal voltages of the second capacitor C2, V(C3) is terminal voltages of the third capacitor C3, and V(C4) is terminal voltages of the fourth capacitor C4. The currents smoothed by the respective capacitors C1, C2, C3, and C4 are supplied to the respective loads. Namely, the load currents I(LED1a-e), I(LED2a-e), I(LED3a-e), and I(LED4a-e) are the currents in which the currents I(D11), I(D21), I(D31), and I(D41) are smoothed.

Accordingly, the current balancing device in embodiment 2 can also obtain the similar effect to the current balancing device in embodiment 1. In addition, current peaks flowing in the loads are lowered since the smoothed currents are supplied to the loads. Therefore, stress on the loads is lowered.

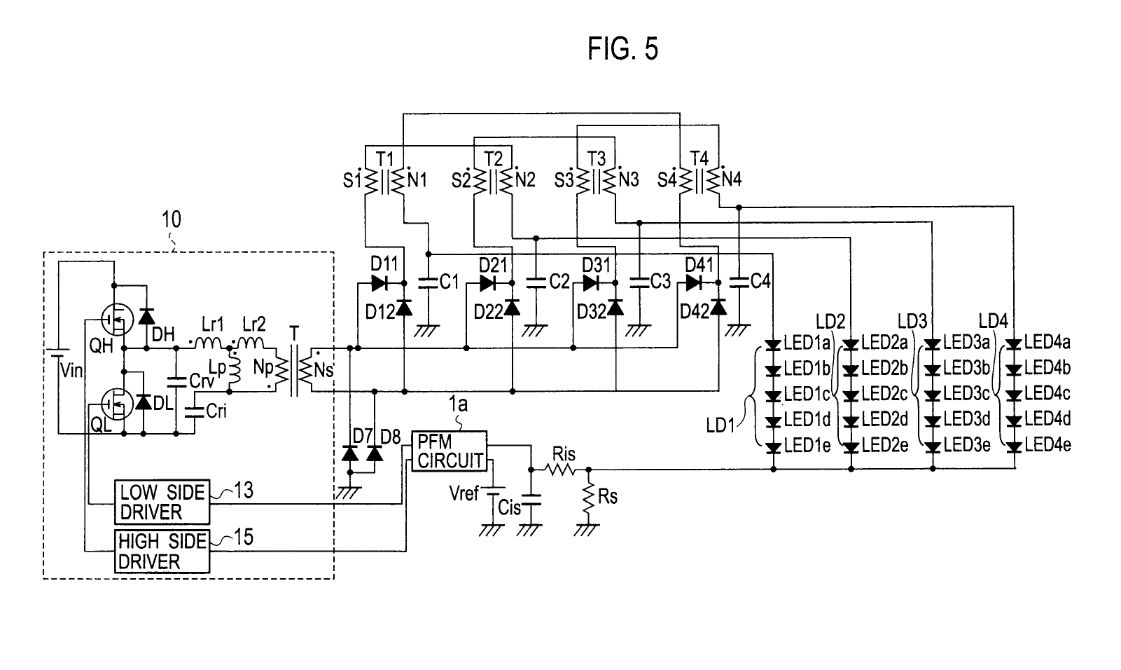

Next, embodiments 3 to 5 illustrated in FIGS. 5 to 7 are methods for magnetically coupling the balance transformers so that each of winding currents is balanced when a plurality of series circuits are connected, which are connected to the power supply 10.

### Embodiment 3

In the current balancing device in embodiment 3 illustrated in FIG. 5, a series circuit of the first load LD1 composed of the diodes D41 and D42, the fourth secondary winding S4, the first primary winding N1, and LED1a to LED1e, a series circuit of the second load LD2 composed of the diodes D11 and D12, the first secondary winding S1, the second primary winding N2, and LED2a to LED2e, a series circuit of the third load LD3 composed of the diodes D21 and D22, the second secondary winding S2, the third primary winding N3, and LED3a to LED3e, and a series circuit of the fourth load LD4 composed of the diodes D31 and D32, the third secondary winding S3, the fourth primary winding N4, and LED4a to LED4e are connected to the output of the power supply 10

The first primary winding N1 and the first secondary winding S1 are magnetically coupled to balance the full-wave rectified currents rectified by the diodes, thereby composing the first balance transformer T1. Similarly, the respective primary windings N2, N3, and N4 and the respective secondary windings S2, S3, and S4 are magnetically coupled to balance the full-wave rectified currents rectified by the diodes, thereby composing the respective the second, third, and fourth balance transformers T2, T3, and T4.

Namely, each of the series circuits includes two windings connected in series, and the respective two windings are magnetically coupled as a primary winding and a secondary winding of each of balance transformers.

With regard to the connection in embodiment 3, each of currents flowing in the respective primary windings N1, N2, N3, and N4 and the respective secondary windings S1, S2, S3, and S4 of the balance transformers T1, T2, T3, and T4 is to be equal to one another due to the characteristics of balance transformer. In other words, the currents supplied from the power supply 10 are balanced, thereby supplying to the loads LD1, LD2, LD3, and LD4. Therefore, the current balancing device in embodiment 3 can also obtain the similar effect to the current balancing device in embodiment 1. Moreover, the two windings are connected to each of the series circuits. Thus, it is possible to downsize the transformers used as a balance transformer, and use the same transformers.

Note that, the smoothing capacitors C1, C2, C3 and C4 may be omitted in embodiment 3.

### Embodiment 4

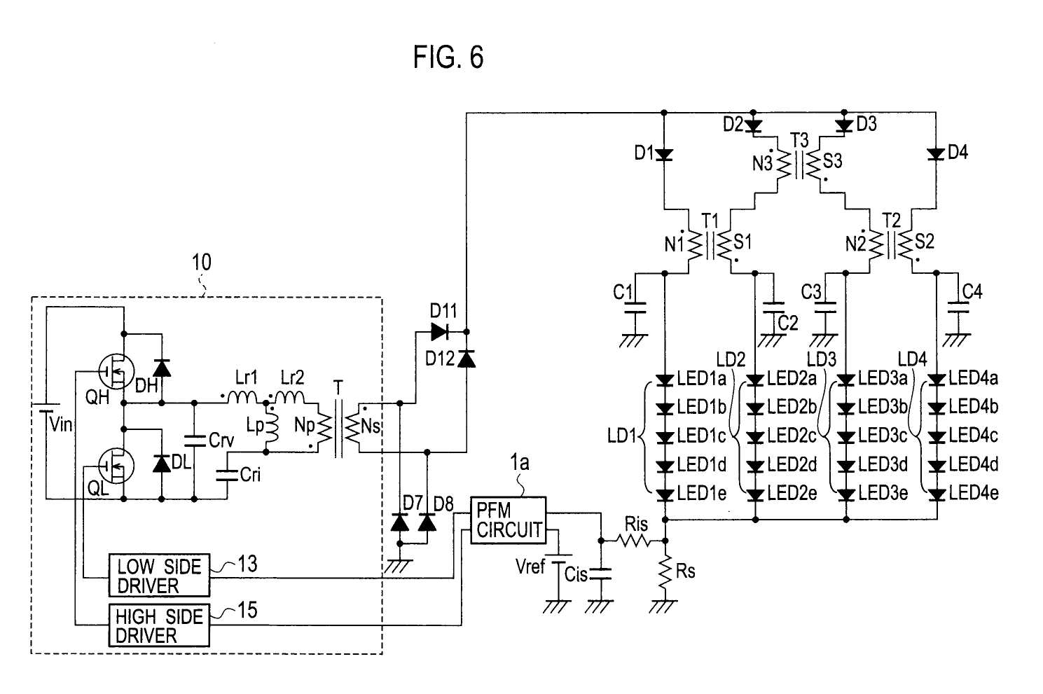

In embodiment 4 illustrated in FIG. 6, one end of the secondary winding Ns of the power transformer T is connected to an anode of the diode D11 and a cathode of the diode D7. The diode D11 performs a half-wave rectification with respect to alternating-current. The other end of the secondary winding Ns of the power transformer T is connected to an anode of the diode D12 and a cathode of the diode D8. The diode D12 performs a half-wave rectification with respect to alternating-current. The diodes D7, D8, D11, and D12 compose a full-wave rectifier. Cathodes of the diodes D11 and D12 are connected to a series circuit of the first load LD1 composed of the diode D1, the first primary winding N1, and LED1a to LED1e, a series circuit of the second load LD2 composed of the diode D2, the third primary winding N3, the first secondary winding S1, and LED2a to LED2e, a series circuit of the third load LD3 composed of the diode D3, the third secondary winding S3, the second primary winding N2, and LED3a to LED3e, and a series circuit of the fourth load LD4 composed of the diode D4, the second secondary winding S2, and LED4a to LED4e.

The first primary winding N1 and the first secondary winding S1 are magnetically coupled to balance the full-wave rectified currents rectified by the diodes D7, D8, D11 and D12, thereby composing the first balance transformer T1. Similarly, the respective primary windings N2 and N3 and the respective secondary windings S2 and S3 are magnetically coupled to balance the full-wave rectified currents rectified by the diodes D7, D8, D11 and D12, thereby composing the respective the second and third balance transformers T2 and T3. Namely, the series circuits including one winding and the series circuits including two windings are provided, and the respective windings are magnetically coupled as a primary winding and a secondary winding of each balance transformer.

With regard to the connection in embodiment 4, each of currents flowing in the respective primary windings N1, N2, and N3 and the respective secondary windings S1, S2, and S3 of the balance transformers T1, T2 and T3 are to be equal to one another due to the characteristics of the balance transfer. Thus, the currents supplied from the power supply 10 are balanced, thereby supplying to the loads LD1, LD2, LD3, and LD4. Therefore, the current balancing device in embodiment 4 can also obtain the similar effect to the current balancing device in embodiment 1. Moreover, the current balancing device in embodiment 4 can remove the fourth balance transformer T4 in embodiments 1 to 3. Accordingly, the current balancing device can be configured inexpensively.

Note that, the smoothing capacitors C1, C2, C3, and C4, or the smoothing capacitors C1, C2, C3, and C4 and the diodes D1, D2, D3, and D4 may be omitted in embodiment 4. Furthermore, as described in embodiment 4, the diodes D11 to D41 and D12 to D42 according to embodiments 1 to 3 can be replaced by each diode D11 and diode D12, respectively.

### Embodiment 5

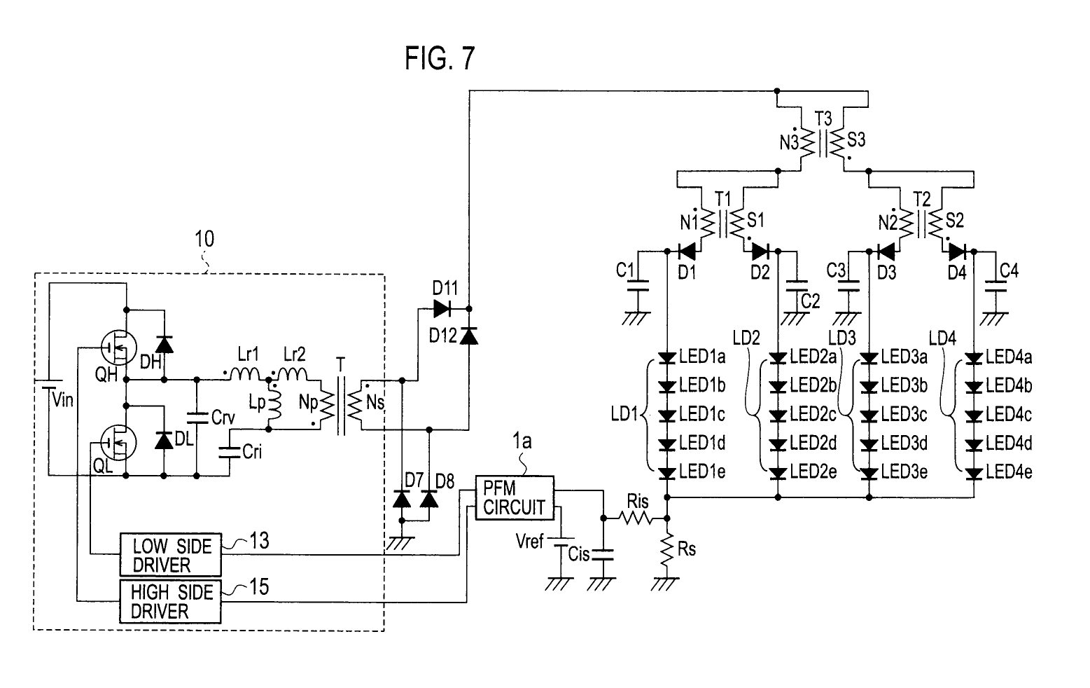

In embodiment 5 illustrated in FIG. 7, both ends of the secondary winding Ns of the power transformer T are connected to the diodes D7, D8, D11, and D12, in which a fill-wave rectification is performed with respect to alternating-current.

Cathodes of the diodes D11 and D12 are connected to a series circuit of the first load LD1 composed of the third primary winding N3, the first primary winding N1, the diode D1, and LED1a to LED1e, a series circuit of the second load LD2 composed of the third primary winding N3, the first secondary winding S1, the diode D2, and LED2a to LED2e, a series circuit of the third load LD3 composed of the third secondary winding S3, the second primary winding N2, the diode D3, and LED3a to LED3e, and a series circuit of the fourth load LD4 composed of the third secondary winding S3, the second secondary winding S2, the diode D4 and LED4a to LED4e. The first primary windings N1, the first secondary winding S1, the second primary winding N2, and the second secondary winding S2 are connected to the smoothing capacitors C1, C2, C3, and C4, respectively, so as to supply the smoothed currents to the respective loads LD1, LD2, LD3, and LD4.

The primary windings N1, N2, and N3 and the secondary windings S1, S2, and S3 are magnetically coupled to balance the full-wave rectified currents rectified by the diodes D7, D8, D11, and 012, thereby composing the balance transformers T1, T2, and T3, respectively. With regard to the connection in embodiment 5, each of currents flowing in the respective primary windings N1, N2, and N3 and the respective secondary windings S1, S2, and S3 of the balance transformers T1, T2, and T3 is to be equal to one another due to the characteristics of balance transformer. Thus, the currents supplied from the power supply 10 are balanced, thereby supplying to the loads LD1, LD2, LD3 and LD4. Therefore, the current balancing device in embodiment 5 can also obtain the similar effect to the current balancing device in embodiment 1. Moreover, the current balancing device in embodiment 5 can remove the fourth balance transformer T4 in embodiments 1 to 3. Accordingly, the current balancing device can be configured inexpensively.

Note that, the smoothing capacitors C1, C2, C3, and C4, or the smoothing capacitors C1, C2, C3, and C4 and the diodes D1, D2, D3, and D4 may be omitted in embodiment 5.

### Embodiment 6

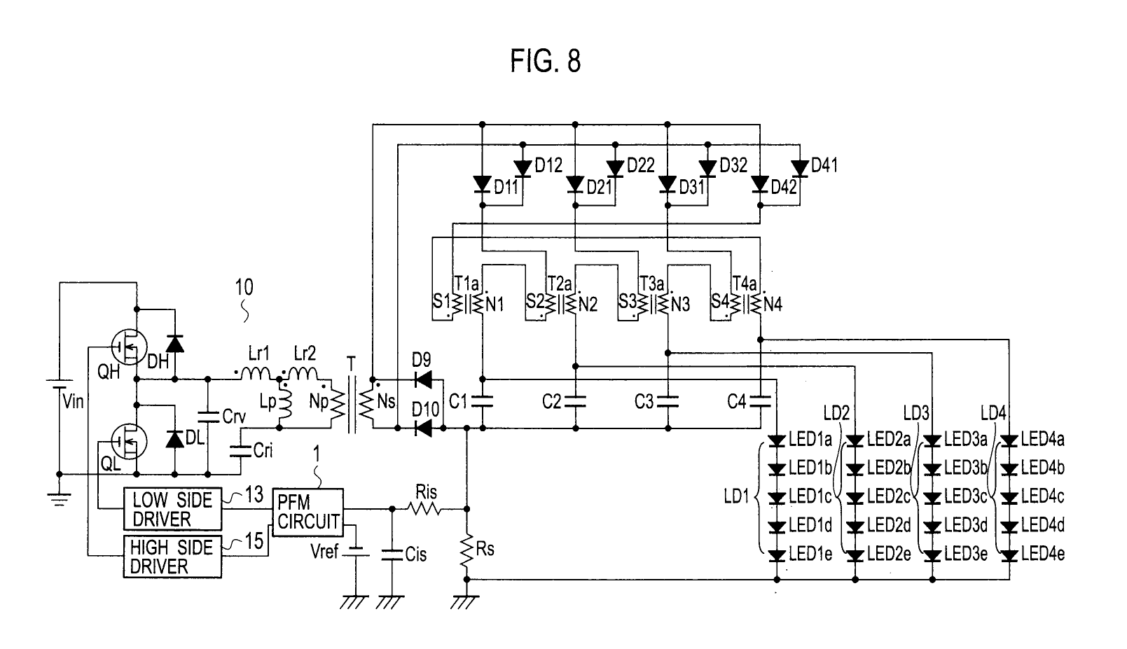

In the current balancing device in embodiment 6 illustrated in FIG. 8, the smoothing capacitors C1, C2, C3, and C4 are connected between the primary windings N1, N2, N3, and N4 of the balance transformers and the secondary winding Ns of the power transformer T, with respect to the current balancing device in embodiment 3 illustrated in FIG. 5. Furthermore, instead of the diodes D7 and D8, diodes 9 and 10 and one end of the resistor Rs are connected between the capacitors C1, C2, C3, and C4 and the secondary winding Ns of the power transformer T. The other configuration is substantially the same as the current balancing device in embodiment 3.

The configuration in embodiment 6 can also obtain the similar effect to the current balancing device in embodiment 1.

Note that, the smoothing capacitors C1, C2, C3, and C4 may be omitted in embodiment 6. Moreover, the power supply 10 in embodiment 6 can connect a plurality of the series circuits described in embodiments 2 to 5.

### Embodiment 7

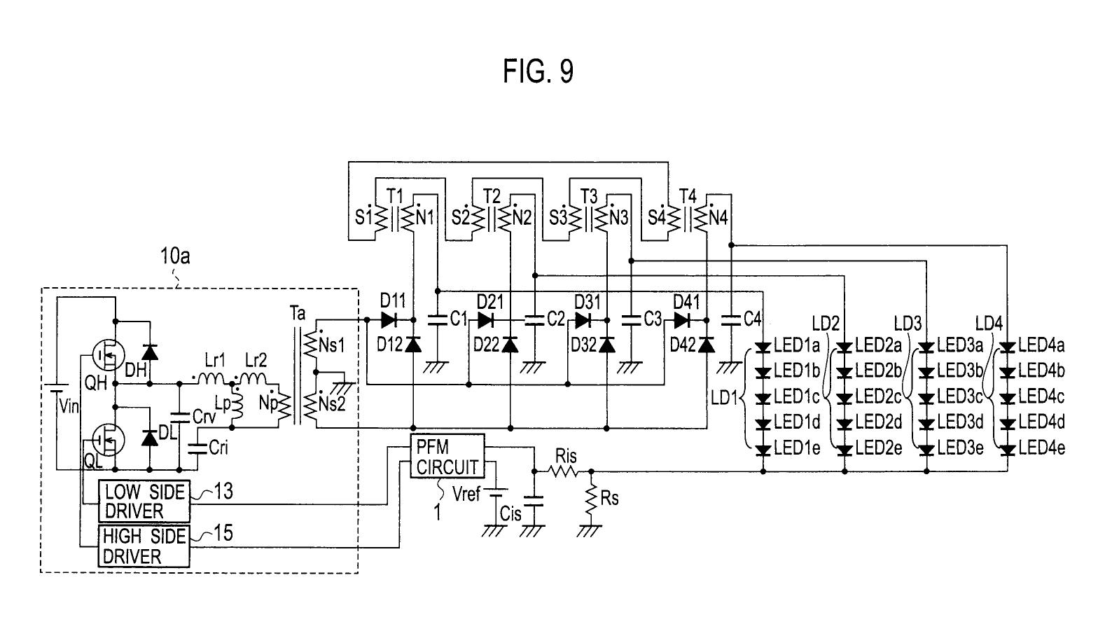

The current balancing device in embodiment 7 illustrated in FIG. 9 employs a second power supply 10a including a center-tap type power transformer Ta instead of the power supply 10, with respect to the current balancing device in embodiment 3 illustrated in FIG. 5. Moreover, the diodes D7 and D8 are omitted.

The center-tap type power transformer Ta includes the primary winding Np, a first secondary winding Ns1 and a second secondary winding Ns2. A central point between the first secondary winding Ns1 and the second secondary winding Ns2 connected in series is connected to a ground (GND). One end of the first secondary winding Ns1 of the center-tap type power transformer Ta is connected to each anode of the diodes D11, D21, D31, and D41. One end of the second secondary winding Ns2 of the center-tap type power transformer Ta is connected to each anode of the diodes D12, D22, D32, and D42. Cathodes of the diodes D11 and D12 are connected to one end of the first primary winding N1. Cathodes of the diodes D21 and D22 are connected to one end of the second primary winding N2. Cathodes of the diodes D31 and D32 are connected to one end of the third primary winding N3. Cathodes of the diodes D41 and D42 are connected to one end of the fourth primary winding N4.

According to the above-described configuration, when the first switching element QH is turned on, currents in the first to fourth series circuits flow in a route along Ns1→D11→N1→the load LD1→Rs→GND (i.e. the central point between the secondary winding Ns1 and the secondary winding Ns2), in a route along Ns1→D21→N2→the load LD2→Rs→GND, in a route along Ns1→D31→N3→the load LD3→Rs→GND, and in a route along Ns1→D41→N4→the load LD4→Rs→GND. Next, when the second switching element QL is turned on, currents in the first to fourth series circuits flow in a route along Ns2→D12→N1→the load LD1→Rs→GND, in a route along Ns2→D22→N2→the load LD2→Rs→GND, in a route along Ns2→D32→N3→the load LD3→Rs→GND, and in a route along Ns2→D42→N4→the load LD4→Rs→GND.

Therefore, the current balancing device in embodiment 7 can also obtain the similar effect to the current balancing device in embodiment 1. In addition, the diodes D7 and D8 can be omitted in embodiment 7. Accordingly, the current balancing device can be configured inexpensively.

Note that, the smoothing capacitors C1, C2, C3 and C4 may be omitted in embodiment 7. Moreover, the second power supply 10a in embodiment 7 can connect the series circuits described in embodiments 2 to 5.

### Embodiment 8

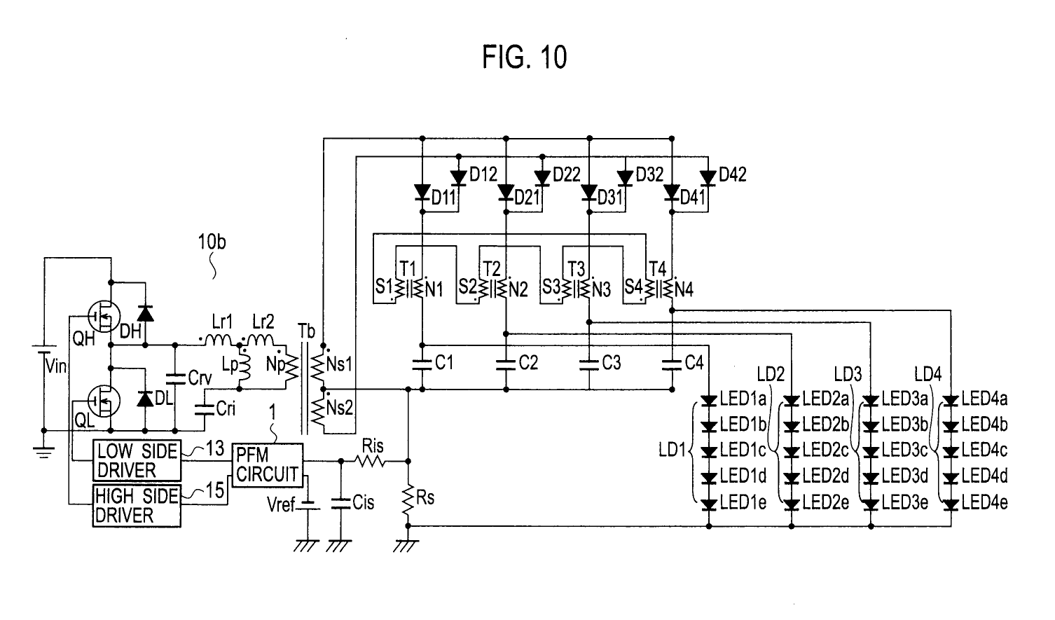

The current balancing device in embodiment 8 illustrated in FIG. 10 employs a third power supply 10b including a center-tap type power transformer Tb instead of the second power supply 10a, and is different in a negative voltage employed as the reference voltage Vref of a PFM circuit 1, with respect to the current balancing device in embodiment 7 illustrated in FIG. 9.

The center-tap type power transformer Tb includes a primary winding Np, a first secondary winding Ns1, and a second secondary winding Ns2. The central point between the first secondary winding Ns1 and the second secondary winding Ns2 connected in series is connected to each one ends of the capacitors C1, C2, C3, and C4 (not GND), one end of the resistor Rs, and one end of the resistor Ris. The other end of the resistor Rs is connected to the GND and each one ends of the loads LD1, LD2, LD3, and LD4. A voltage at a connection point of one end of the resistor Rs and one end of the resistor Ris is a negative voltage. Therefore, in embodiment 8, negative voltage is employed as the reference voltage Vref of the PFM circuit 1.

The configuration in embodiment 8 can also obtain the similar effect to embodiment 7 due to approximately similar operations to the current balancing device in embodiment 7 illustrated in FIG. 9. In addition, the diodes D7 and D8 can be removed in embodiment 8. Accordingly, the current balancing device can be configured inexpensively.

Moreover, the central point between the first secondary winding Ns1 and the second secondary winding Ns2 of the center-tap type power transformer Tb may be connected to each one ends of the capacitors C1, C2, C3, and C4 (not GND), and one end of the resistor Rs. The other end of the resistor Rs may be connected to the GND, each one ends of the loads LD1, LD2, LD3, and LD4, and one end of the resistor Ris. In this case, a positive voltage can be employed as the reference voltage Vref.

Note that, the smoothing capacitors C1, C2, C3, and C4 may be omitted in embodiment 8. Moreover, the third power supply 10b in embodiment 8 can connect the series circuits described in embodiments 2 to 5.

### Embodiment 9

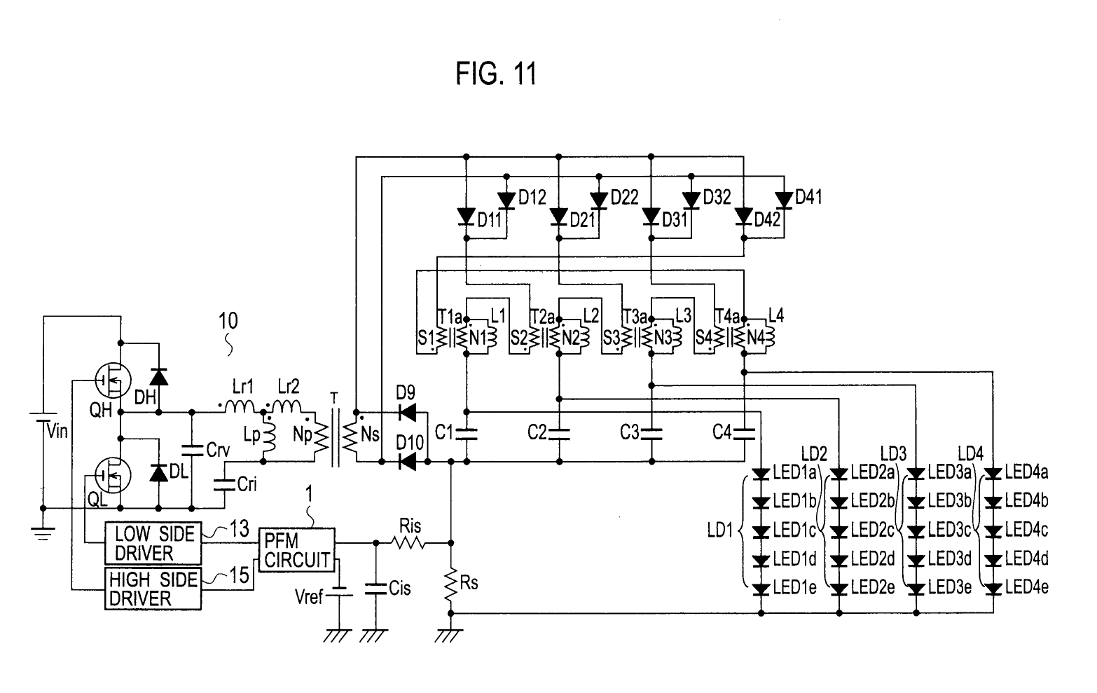

The current balancing device in embodiment 9 illustrated in FIG. 11 turns off the first switching element QH after the balance transformers are reset in order not to superimpose direct-current on the balance transformers.

The current balancing device in embodiment 9 illustrated in FIG. 11 has substantially the same functions as the current balancing device in embodiment 6 illustrated in FIG. 8. However, the circuit diagram in FIG. 11 separately indicates the balance transformers T1, T2, T3, and T4 in embodiment 6 as ideal transformers T1a, T2a, T3a, and T4a and magnetizing inductances L1, L2, L3, and L4. In embodiment 9, resetting of the ideal transformers T1a, T2a, T3a and T4a and off control of the first switching element QH are mainly explained.

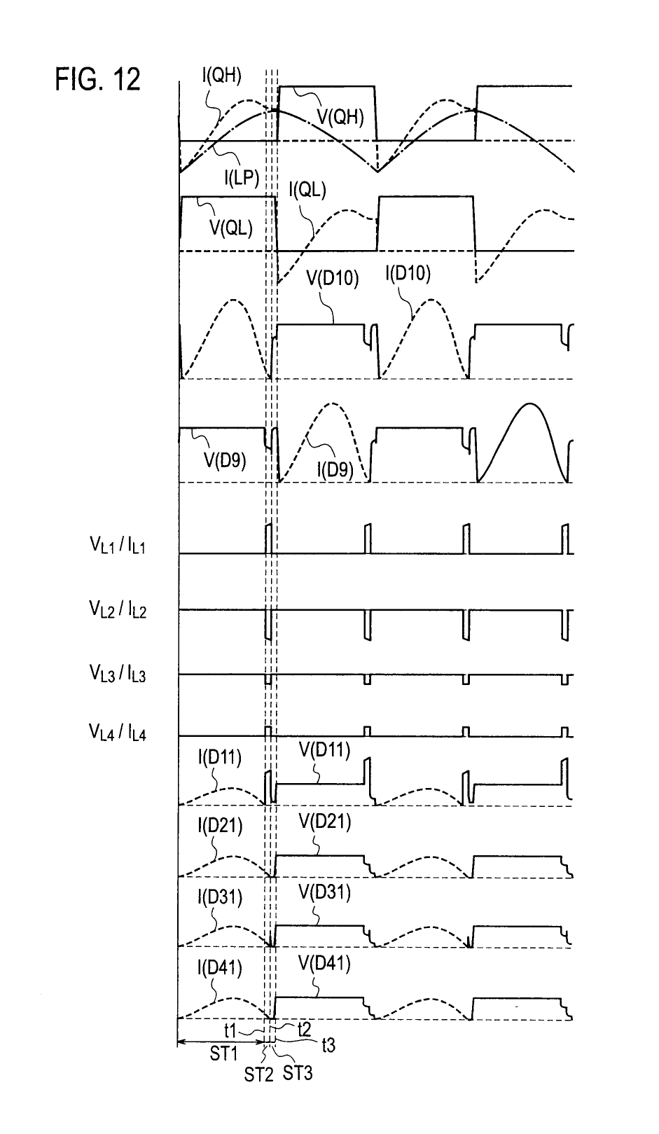

FIG. 12 is operational waveforms for explaining reset operations of the balance transformers of the current balancing device in embodiment 9 of the present invention. In FIG. 12, a period when currents supplied from the primary winding Np flow from the secondary winding Ns represents ST1, a period when the ideal transformers T1a, T2a, T3a and T4a are reset represents ST2, and a period when the first switching element QH is turned off after resetting of each ideal transformer is finished represents ST3.

The first switching element QH is turned on during the period ST1. The currents from the secondary winding Ns flow in a first path along Ns→D11→S2→N1→C1 (LD1)→D10→Ns, in a second path along Ns→D21→S3→N2→C2 (LD2)→D10→Ns, in a third path along Ns→D31→S4→N3→C3 (LD3)→D10→Ns, and in a fourth path along Ns→D41→S1→N4→C4 (LD4)→D10→Ns. Therefore, the current flowing in the first primary winding N1 is equal to the current flowing the first secondary winding S1, the current flowing in the second primary winding N2 is equal to the current flowing the second secondary winding S2, the current flowing in the third primary winding N3 is equal to the current flowing the third secondary winding S3, and the current flowing in the fourth primary winding N4 is equal to the current flowing the fourth secondary winding S4. Thus, the currents flowing in the first to fourth paths are equal, respectively.

The period ST2 is a period when the currents stored in the magnetizing inductances L1 to L4 of the ideal transformers T1a to T4a are reset. The currents stored in the magnetizing inductances L1 to L4 in the period ST1 generate voltages in a direction opposite to a forward bias direction of diodes Dm composing each series circuits. Thus, the diodes Dm, composing each series circuit are supplied with the reverse voltages.

A condition to generate the maximum reverse voltages during the reset period ST2 is met when Vc1, i.e. a sum of voltage drops of LED1a to LED1e in a forward bias direction is a maximum value of variation, and when each Vc2, Vc3 and Vc4, i.e. each sum of voltage drops of LEDxa to LEDxe (x=2 to 4) in a forward bias direction is a minimum value of variation, for example. In this case, only the diode D11 is supplied with the reverse voltage during the reset period ST2.

If the first switching element QH is turned off during the reset period ST2, the voltage of the primary winding of the power transformer T becomes a negative voltage in a winding start. Then, the voltage of the secondary winding of the power transformer T also becomes a negative voltage in a winding start. As a result, the reverse voltage is further superimposed on the diode D11.

Meanwhile, the switching element QH is turned off at a time t3 after passing a time t2 at which the current flowing in the inductance L1 (also L2, L3, L4) is zero and the reset periods of the ideal transformers T1a to T4a are finished. Thus, the reverse voltage in the diode D11 can be suppressed to a low level.

As the parallel number of the loads increases, the reverse voltages supplied to the diodes composing each series circuit increase. As a result, a diode with a high dielectric strength is required, which causes a high cost of the current balancing device.

Therefore, reverse controlling of the voltages of the transformers in the current balancing device is highly effective in embodiment 9 after on/off control of the first switching element QH and the second switching element QL during the reset period ST2 and after finishing resetting the balance transformers. Due to such a control, a diode with a low dielectric strength can be used as a diode composing each of series circuits. Thus, the current balancing device can be configured inexpensively. Moreover, the switching element QH is turned off after the balance transformers are reset. Accordingly, it is possible not to superimpose direct-current on the balance transformers.

In addition, the current balancing device of the present invention can be applied to an LED lighting device and an LCD B/L module, for example.

The LED lighting device includes: a power converter that converts an ac power from a commercial ac power source to an arbitrary ac power so as to supply alternating-current; and a current balancing device that balances first currents and a second current based on an electromagnetic force generated in one or more of windings, the first currents flowing in a plurality of series circuits, each of the series circuit including a full-wave rectifier connected to an output of the power converter and performing full-wave rectification for the alternating-current, one or more of the windings, and one or more of LED loads in series connection, and the second current flowing in one or more of the LED loads.

The LCD B/L module includes: an LCD cell; and a current balancing device that balances first currents and a second current based on an electromagnetic force generated in one or more of windings, the first currents flowing in a plurality of series circuits, each of the series circuit including a full-wave rectifier, one or more of the windings, and one or more of LED loads in series connection, the second current flowing in one or more of the LED loads, the full-wave rectifier connected to an output of a power converter that converts an ac power from a commercial ac power source to an arbitrary ac power so as to supply alternating-current and performing full-wave rectification for the alternating-current.

What is claimed is:

1. A current balancing device, comprising:
a power supply that outputs sinusoidal alternating-current; and
a plurality of series circuits, each of the series circuits including a full-wave rectifier, one or more of windings, and one or more of loads in series connection, the full-wave rectifier connected to an output of the power supply and performing full-wave rectification for the alternating-current of the power supply, wherein
currents flowing in the respective series circuits are balanced based on an electromagnetic force generated in one or more of the windings.

2. The current balancing device of claim 1, wherein
the loads have a rectifying property.

3. The current balancing device of claim 1, wherein
currents provided by smoothing the alternating-current are supplied to the loads.

4. The current balancing device of claim 1, wherein
the power supply includes a series resonant circuit for supplying the sinusoidal alternating-current, a voltage source, and switches.

5. The current balancing device of claim 4, wherein
the power supply turns off the switches that are on state during supplying the currents to the series circuits after sinusoidal half-wave currents supplied to the series circuits reach to zero and a reset of one or more of the windings is finished.

6. The current balancing device of claim 1, wherein
the power supply includes a transformer in which a potential at a central point between secondary winding is constantly maintained, and
the central point between the secondary winding of the transformer is connected to one or more of the loads.

7. The current balancing device of claim 4, wherein
a transformer is composed of one or more of the windings, and
the power supply turns off the switches that are on state during supplying the currents to the series circuits after a current flowing in a magnetizing inductance of the transformer reaches to zero.

8. The current balancing device of claim 1, further comprising:
a current detector for detecting the currents flowing the series circuits;
a comparator for comparing current detection values detected at the current detector to a reference value; and
a controller for controlling the alternating-current according to an output of the comparator.

9. An LED lighting device, comprising:
a power converter for converting an ac power from a commercial ac power source to an arbitrary ac power so as to supply alternating-current; and
a current balancing device for balancing first currents and a second current based on an electromagnetic force generated in one or more of windings, the first currents flowing in a plurality of series circuits, each of the series circuits including a full-wave rectifier connected to an output of the power converter and performing full-wave rectification for the alternating-current, one or more of the windings, and one or more of LED loads in series connection, and the second current flowing in one or more of the LED loads.

10. An LCD B/L module, comprising:
an LCD cell; and
a current balancing device that balances first currents and a second current based on an electromagnetic force generated in one or more of windings, the first currents flowing in a plurality of series circuits, each of the series circuit including a full-wave rectifier, one or more of the windings, and one or more of LED loads in series connection, the second current flowing in one or more of the LED loads, the full-wave rectifier connected to an output of a power converter that converts an ac power from a commercial ac power source to an arbitrary ac power so as to supply alternating-current and performing full-wave rectification for the alternating-current.
